(19) United States
(12) Patent Application Publication
(10) Pub. No.: US 2012/0086176 A1
(43) Pub. Date: Apr. 12, 2012

(54) SEAL STRUCTURE USING GASKET

(75) Inventors: Hiroya KONDOU, Toyohashi-shi (JP); Kenji FUKUMOTO, Kuwana-shi (JP); Hiroki TADAUCHI, Hamamatsu-Shi (JP); Shuhei MARUKAWA, Toyohashi-shi (JP)

(73) Assignee: PRIMEARTH EV ENERGY CO., LTD., Shizuoka (JP)

(21) Appl. No.: 13/244,166

(22) Filed: Sep. 23, 2011

(30) Foreign Application Priority Data
Oct. 8, 2010 (JP) 2010-229083
Jul. 28, 2011 (JP) 2011-165325

(51) Int. Cl. F16J 15/02

(52) U.S. Cl. 277/631

(57) ABSTRACT

A gasket arranged between two sealed subject surfaces includes a plurality of segments. A recess is arranged in one of the two sealed subject surfaces at a portion corresponding to a clearance between adjacent segments. A seal is filled in the recess and deformed in accordance with the shape of the clearance between the segments.

### CROSS-REFERENCE TO RELATED APPLICATIONS

This application is based upon and claims the benefit of priority from prior Japanese Patent Applications No. 2010-229083, filed on Oct. 8, 2010, and No. 2011-165325, filed on Jul. 28, 2011, the entire contents of which are incorporated herein by reference.

### BACKGROUND OF THE INVENTION

The present invention relates to a seal structure that seals two opposing portions with a gasket, and more particularly, to a seal structure that is advantageous when used with a gasket formed by separate segments.

A case that accommodates an electronic device, such as a hard disk drive, is generally required to be hermetic and waterproof (moisture-proof). A gasket is used as a seal for such a case. For example, when a gasket is used to fix a body and lid of a case, the gasket is formed so that its shape is in conformance with that of the portions it opposes. Japanese Laid-Open Patent Publication No. 2002-71022 describes an example of a prior art gasket.

As shown in FIG. 1, a gasket 4, which is described in the above publication, has a shape that conforms to the shape of sealed portions of, for example, a lid and a case. The gasket 4 is a laminate of a seal member 5, which is formed from, for example, a polyurethane or EPDM (ethylene propylene diene terpolymer) foam, and a thermal adhesion film 6. When manufacturing the gasket 4, as shown in FIG. 2, a seal 6a, which forms the thermal adhesion film 6, is superimposed on a sheet 5a, which forms the seal member 5. The laminate of the seal 6a and sheet 5a is heated and compressed by a heat roller 8 to form a laminated sheet 7. Then, as shown in FIG. 3, a gasket 4 is punched out of the laminated sheet 7. The gasket 4 has a shape that conforms to the shape of a sealed portion.

Enlargement of a case enlarges the gasket used for the case. This increases the circumferential length of the gasket. In such a case, when a punching process, such as that described above, is performed to form the gasket, the yield of the gasket material becomes low. For example, a battery pack is used as a power supply for an electric motor that functions as a power source or auxiliary power source of an electric vehicle or hybrid vehicle. Such a battery pack normally includes a battery container, which accommodates a plurality of battery modules. The battery container also uses a gasket. In such a battery pack, to obtain the power required for the power source of an automobile, enlargement of the battery pack is inevitable. This results in enlargement of the battery container, which leads to an increased circumferential length of the gasket used for the battery container.

Referring to FIG. 4, when manufacturing a gasket for a large box such as a battery container, each side of the gasket may be punched out separately from the other sides. More specifically, first to fourth segments 11 to 14, which respectively correspond to the four sides of a gasket 10, are punched out from a laminated sheet. Then, the first to fourth segments 11 to 14 are coupled together to form the gasket 10. By separating a gasket in this manner, the yield of the gasket material can be improved even when the box that uses the gasket is enlarged.

The structure of such segments in the prior art will now be described. FIG. 5 is an enlarged view showing one corner of the gasket 10 mentioned above (encircled portion denoted by A). As shown in FIG. 5, the first segment 11 has an end including a projection 11a, a recess 11b, and a projection 11c. In the same manner, the second segment 12 includes an end including a recess 12a, a projection 12b, and a projection 12c. The projection 11a and recess 11b of the first segment 11 are respectively engaged with the recess 12a and projection 12b of the second segment 12. Further, the projection 12c of the second segment 12 is superimposed on the projection 11c of the first segment 11. A fastener 20, such as a rivet, couples the first and second segments 11 and 12. The projections 11c and 12c are formed at the inner side of the gasket 10 so that they do not interfere with the coupling of the gasket 10 to the container. However, when the gasket has such a structure, the formation of a gap S, even though it may be small, cannot be avoided at the portion at which the first and second segments 11 and 12 are engaged with each other. Such a gap S adversely affects the sealing performance when the gasket 10 is coupled to a container.

### SUMMARY OF THE INVENTION

The present invention provides a seal structure using a gasket that uses separate segments to improve material yield while maintaining a high sealing performance.

One aspect of the present invention is a seal structure including a gasket arranged between two sealed subject surfaces. The gasket includes a plurality of segments. A recess is arranged in one of the two sealed subject surfaces at a portion corresponding to a clearance between adjacent ones of the plurality of segments. A seal is filled the recess and deformed in conformance with the shape of the clearance between the segments.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic perspective view showing a gasket of the prior art;

FIG. 2 is a perspective view showing a process for manufacturing a gasket in the prior art;

FIG. 3 is a perspective view showing one example of a punching process for manufacturing a gasket in the prior art;

FIG. 4 is a schematic diagram showing a gasket of the prior art formed by separate segments;

FIG. 5 is an enlarged plan view showing the encircled portion in FIG. 4;

FIG. 6 is a perspective view showing a battery pack to which a seal structure using a gasket according to a first embodiment of the present invention is applied;

FIG. 7 is an exploded perspective view showing the battery pack of FIG. 6;

FIG. 8 is a perspective view showing a lower case, which is shown in FIG. 7;

FIG. 9 is a perspective view showing an upper case, which is shown in FIG. 7;

FIG. 10 is an enlarged perspective view showing the seal structure formed between a flange of the lower case and a flange of the upper case;

FIG. 11 is a plan view showing the seal structure of FIG. 10;

FIGS. 12A and 12B are cross-sectional views the seal structure taken along line A-A in FIG. 11;

FIG. 13 is a schematic plan view showing a plurality of segments forming a gasket of a seal structure according to a second embodiment of the present invention;

FIG. 14 is an exploded perspective view showing a battery pack to which the seal structure of FIG. 13 is applied;

FIG. 15 is an exploded perspective view showing a battery pack to which a seal structure using a gasket according to a third embodiment of the present invention is applied;

FIG. 16 is a schematic perspective view showing a flap formed on a segment of the gasket shown in FIG. 15;

FIG. 17 is a perspective view showing a battery pack to which a seal structure using a gasket according to a fourth embodiment of the present invention is applied;

FIG. 18A is a plan view showing a short side of a lower flange, which is shown in FIG. 17, and a first segment, which seals the short side;

FIG. 18B is a plan view showing the first segment of FIG. 18A in a state coupled to the short side of the lower flange;

FIG. 19A is a schematic plan view showing a gasket used in a seal structure according to a fifth embodiment of the present invention;

FIG. 19B is an enlarged cross-sectional view of the gasket taken along line A-A in FIG. 19A;

FIG. 20A is a cross-sectional view showing a battery pack to which the gasket of FIG. 19A is coupled as viewed from the short side of the battery;

FIG. 20B is an enlarged cross-sectional view showing the encircled part of the battery pack in FIG. 20A;

FIG. 21A is a schematic plan view showing a gasket used in a seal structure according to a further embodiment of the present invention;

FIG. 21B is an enlarged cross-sectional view of the gasket taken along line A-A in FIG. 21A;

FIG. 22A is a schematic plan view showing a gasket used in a seal structure according to another embodiment of the present invention;

FIG. 22B is an enlarged cross-sectional view of the gasket taken along line A-A in FIG. 22A;

FIGS. 23A to 23C are enlarged cross-sectional views showing examples of gaskets used in seal structures according to further embodiments of the present invention;

FIG. 24A is a plan view showing segments before they are engaged with each other in a gasket for a seal structure according to a further embodiment of the present invention;

FIG. 24B is a plan view showing the segments of FIG. 24A after they are engaged with each other;

FIG. 25A is a plan view showing segments before they are engaged with each other in a gasket for a seal structure according to a further embodiment of the present invention;

FIG. 25B is a plan view showing the segments of FIG. 25A after they are engaged with each other;

FIG. 26A is a plan view showing segments before they are engaged with each other in a gasket for a seal structure according to a further embodiment of the present invention; and

FIG. 26B is a plan view showing the segments of FIG. 26A after they are engaged with each other.

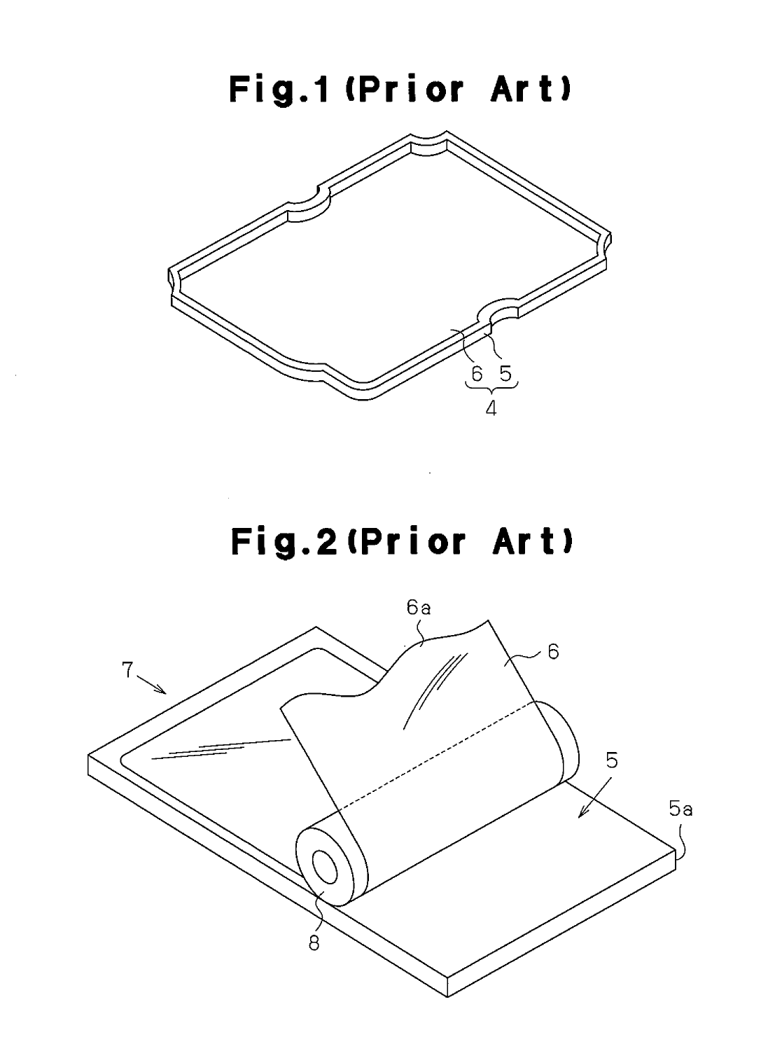

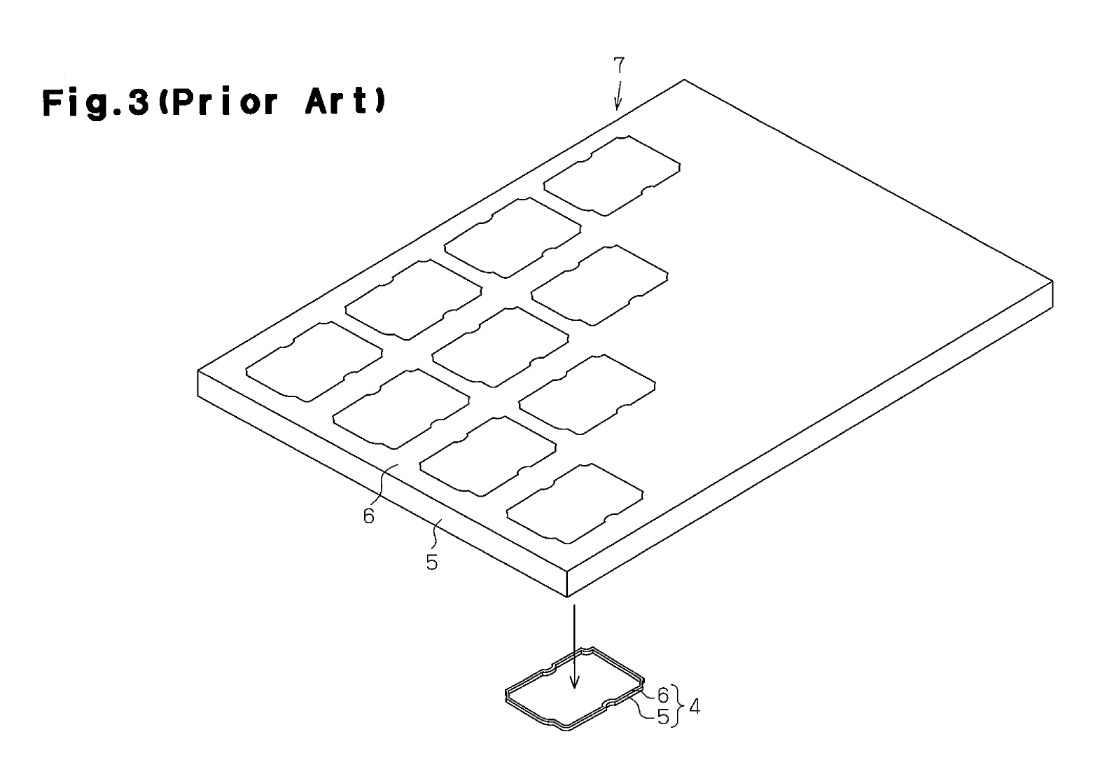

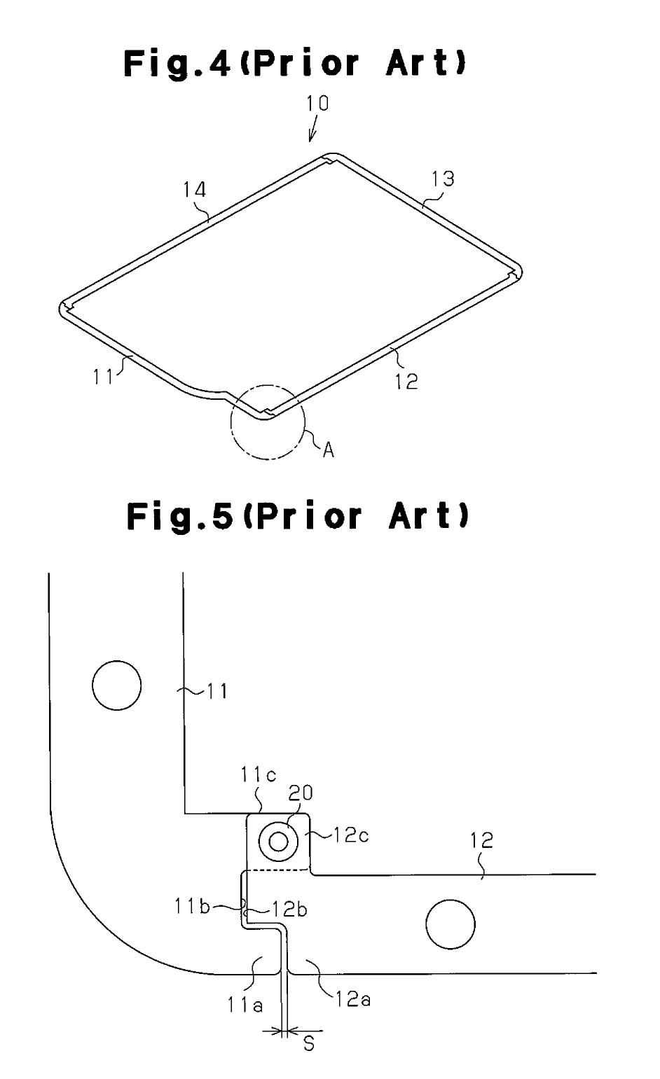

### DETAILED DESCRIPTION OF THE INVENTION

### First Embodiment

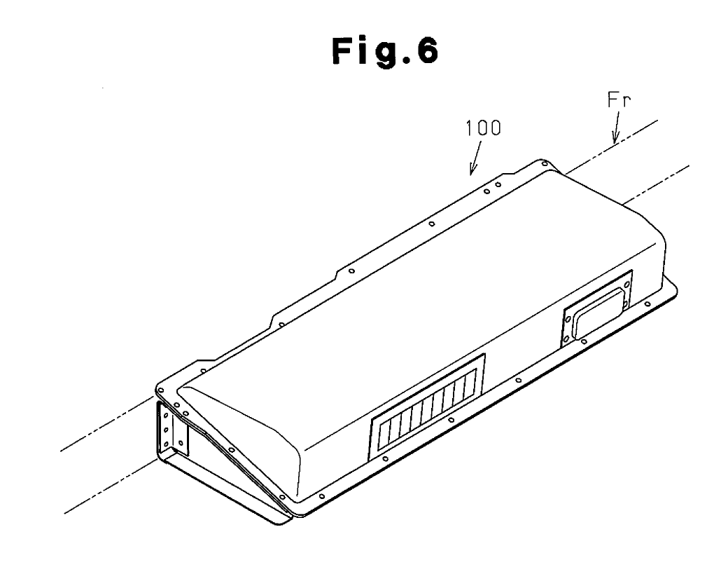

A seal structure using a gasket according to a first embodiment of the present invention will now be described with reference to FIGS. 6 to 12.

FIG. 6 shows a battery pack 100 to which a seal structure according to a first embodiment of the present invention is applied. The battery pack 100 is arranged on a vehicle frame Fr, which forms part of a bed in a truck that serves as an electric vehicle or a hybrid vehicle. The battery pack 100 is used as a power unit, which is a power source for supplying power to an electric motor that functions as a main power source or auxiliary power source of the truck.

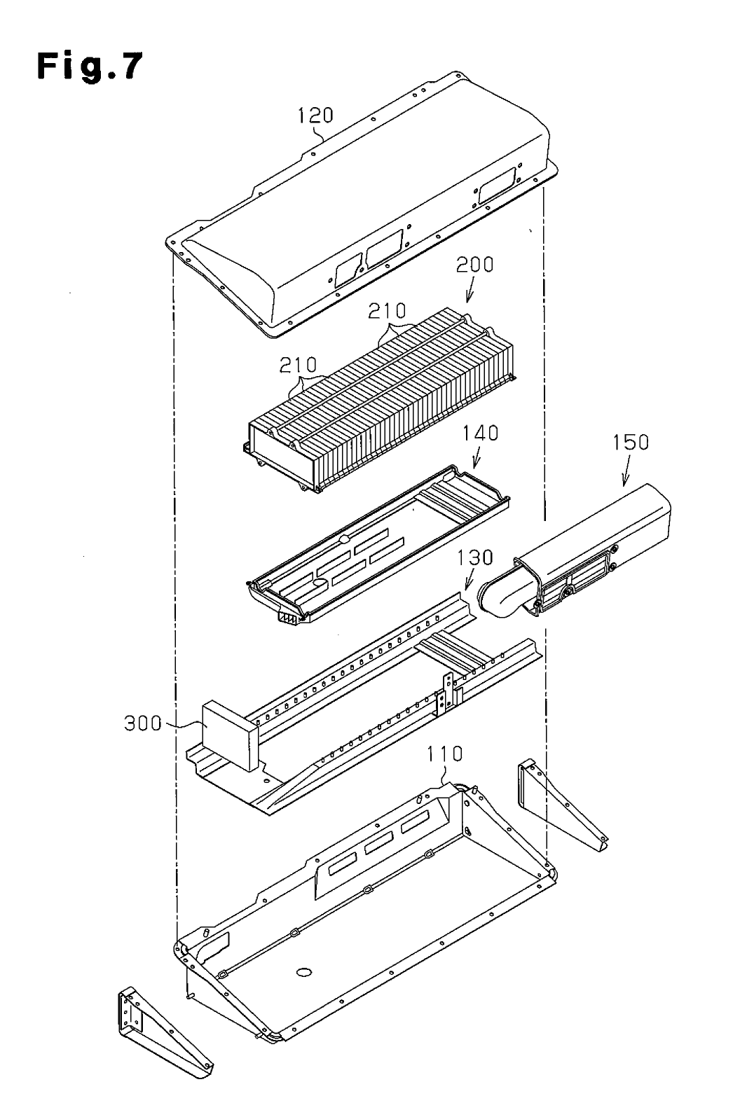

FIG. 7 is an exploded view of the battery pack 100. The battery pack 100 includes a battery container that accommodates a battery stack 200, which includes a plurality of battery modules 210 (rechargeable batteries). The battery container is a closed box and formed by a lower case 110 and an upper case 120, each having a rectangular opening. In the first embodiment, the lower case 110 and the upper case 120 each have a monocoque structure. More specifically, the lower case 110 and the upper case 120 each include an outer plate functioning as a rigid body that receives stress. In this manner, the battery container, which is box-shaped, closed, and obtained by joining the lower case 110 and upper case 120, has a monocoque structure. The battery container is rigid enough to keep holding the battery stack 200 therein when vibration is received from the vehicle frame Fr as the truck travels.

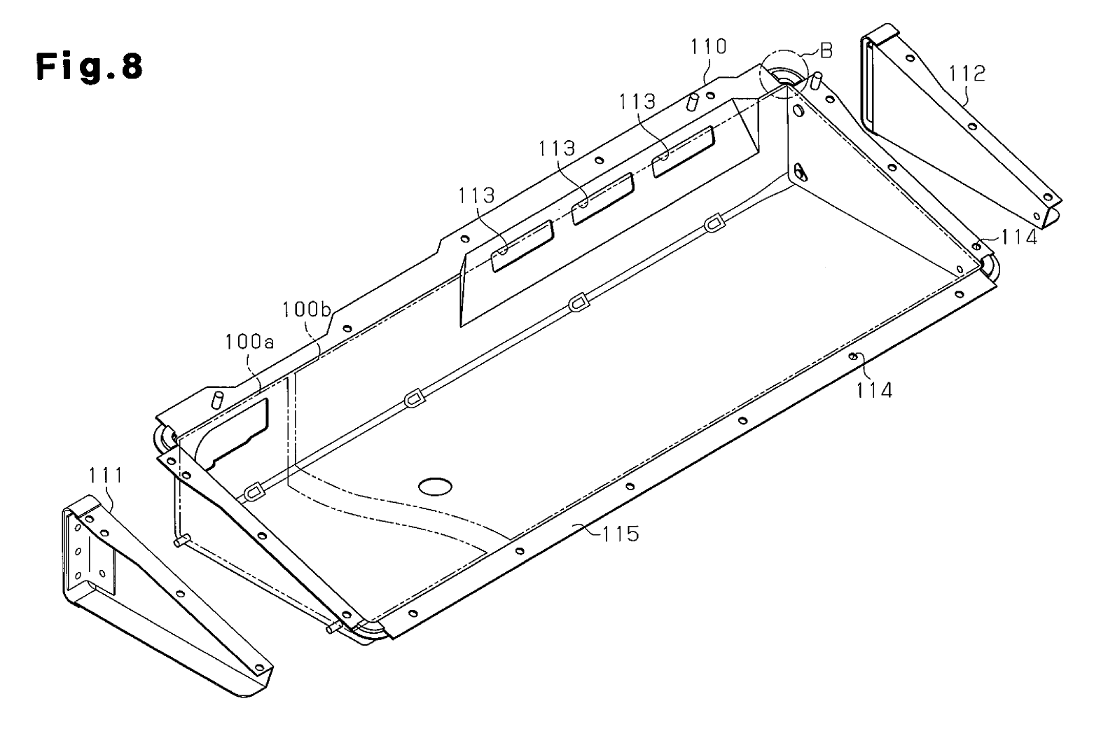

As shown in FIG. 8, the lower case 110 includes two triangular carrier brackets 111 and 112, which are arranged on opposite longitudinal ends of the lower case 110 and coupled to the vehicle frame Fr. The lower case 110 is divided into a device area 100a and a battery area 100b. The battery area 100b accommodates the battery stack 200. The device area 100a accommodates a management device 300, which controls and manages the state of the battery stack 200. Three air outlets 113 are arranged in the upper rear surface of the lower case 110 to discharge air that has cooled the battery stack 200 from the battery pack 100. A rectangular lower flange 115 extends entirely around the lower flange 115. Thus, the lower flange 115 includes four corners. Further, the lower flange 115 includes coupling holes 114, which are used to couple the lower case 110 with the upper case 120 using bolts and nuts.

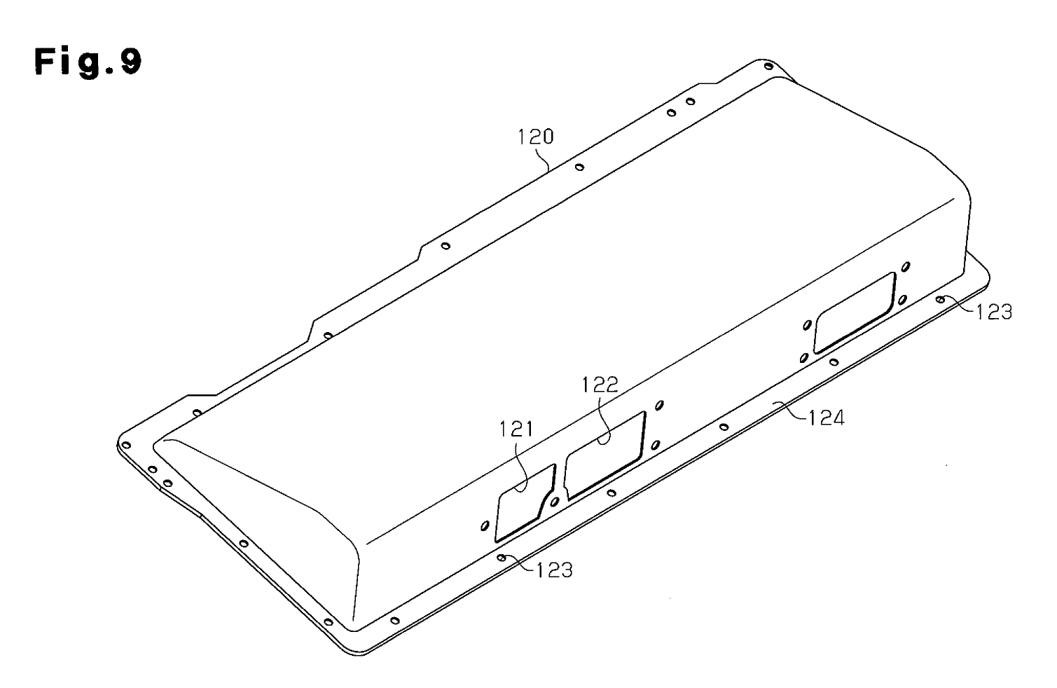

Referring to FIG. 9, the upper case 120 includes air inlets 121 and 122, which are arranged in a front surface of the upper case to draw air into the battery pack 100 and cool the battery stack 200. A rectangular upper flange 124, which opposes the lower flange 115 of the lower case 110, extends entirely around the upper flange 124. Thus, the upper flange 124 includes four corners. Further, the upper flange 124 includes coupling holes 123, through which bolts are inserted, at positions corresponding to the coupling holes 114 of the lower case 110.

Referring to FIG. 7, the lower case 110 accommodates a frame 130, a tray 140, a duct 150, the battery stack 200, and the management device 300. The frame 130 fixes the battery stack 200 to the lower case 110. The tray 140, which is arranged on the frame 130, forms an air passage that supplies air to the battery stack 200. The duct 150 is connected to the tray 140, and the ambient air drawn into the battery pack 100 is supplied to the tray 140. In a state in which the frame 130, the tray 140, the duct 150, the battery stack 200, and the management device 300 are accommodated in the lower case 110, the upper case 120 is coupled to the lower case 110 to form the battery pack 100.

The battery pack 100 accommodates the battery stack 200 and the management device 300 and is thus required to be hermetic and waterproof (moisture-proof). In particular, in the first embodiment, the battery pack 100 is arranged outside the vehicle, and the interior of the battery pack 100 should be protected from rain and ambient air, which includes dust. Thus, a seal is required between the portion at which the lower case 110 and upper case 120 are coupled to each other. More specifically, a seal is required at the surface of the lower flange 115 opposing the upper flange 124 and a surface of the upper flange 124 opposing the lower flange 115.

The seal structure of the first embodiment includes a gasket arranged between two sealed subject surfaces, namely, the opposing surface of the lower flange 115 and the opposing surface of the upper flange 124. The gasket is shaped in conformance with the lower flange 115 and the upper flange 124.

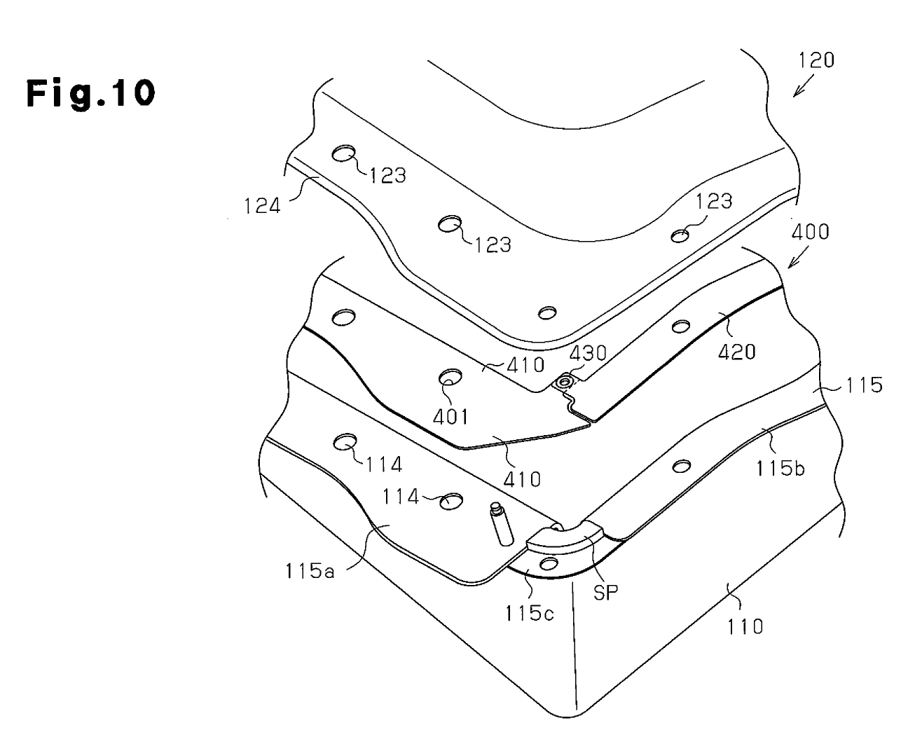

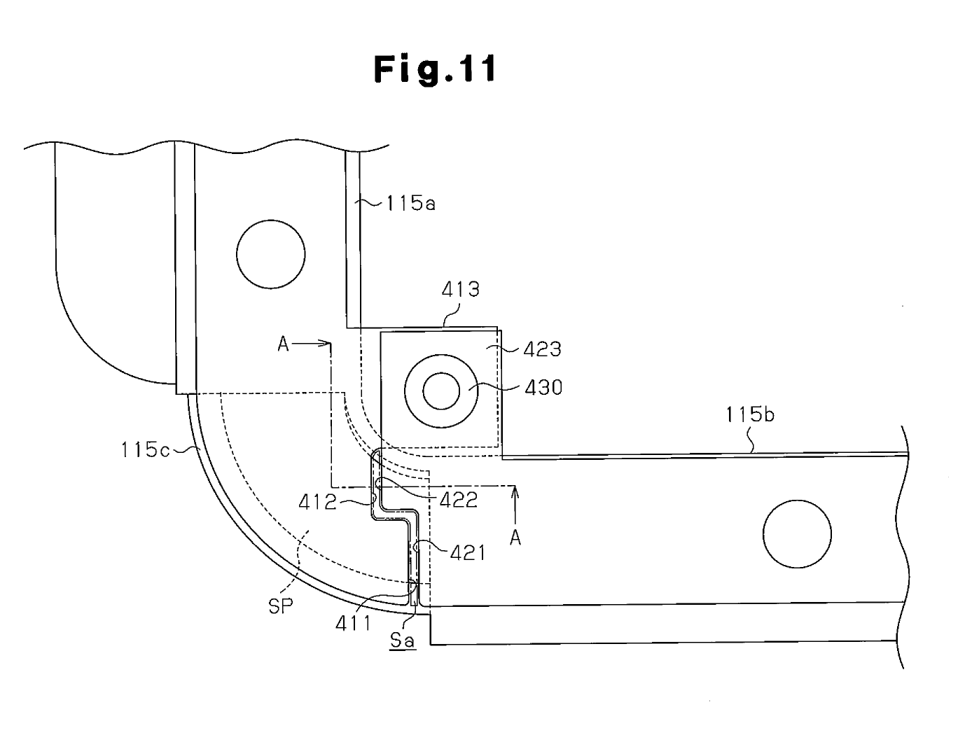

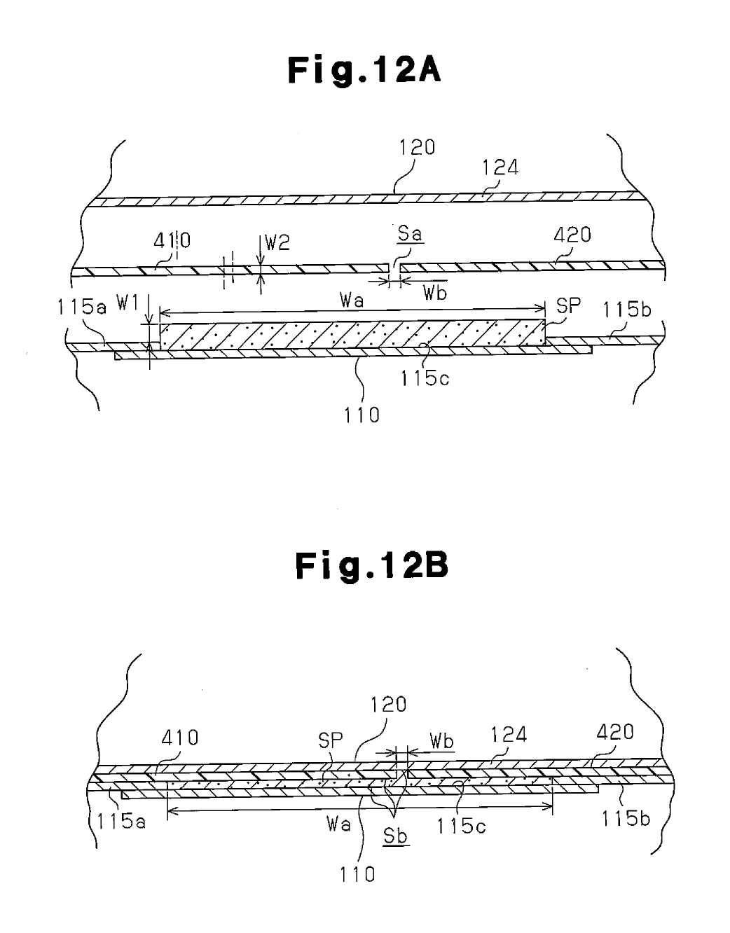

The seal structure of the first embodiment will now be described with reference to FIGS. 10 to 12. FIG. 10 is an enlarged view showing one corner of the lower case 110 (encircled portion denoted by reference character B in FIG. 8). FIG. 11 is an enlarged view showing the corner of the lower case 110 as viewed from above a gasket 400. FIGS. 12A and 12B are cross-sectional views showing the seal structure taken along line A-A in FIG. 11. FIG. 12A is a cross-sectional view showing the seal structure before the lower case 110 and upper case 120 are coupled to each other. FIG. 12B is a cross-sectional view showing the seal structure after the lower case 110 and upper case 120 are coupled to each other.

Referring to FIG. 10, in the first embodiment, the gasket 400 has a closed tetragonal shape, which conforms to the shape of the lower flange 115 and upper flange 124, and includes four corners. The gasket 400 includes first to fourth segments, each corresponding to one side of the gasket 400. FIG. 10 shows only the first to second segments 410 and 420. In this manner, the gasket 400 is divided into four segments, and each segment includes a portion at which the segment is separated from another segment. The separated portion corresponds to one of the four corners of the gasket. In other words, the separated portions of the gasket 400 correspond to the four corners of the lower flange 115, which is the sealed subject of the lower case 110. The gasket 400 includes coupling holes 401, which correspond to the coupling holes 114 of the lower case 110 and the coupling holes 123 of the upper case 120. Bolts are inserted into the coupling holes 401. The gasket 400 is formed from, for example, a metal plate coated with a silicone rubber, a fluorine rubber, an ethylene propylene rubber, or the like.

In the first embodiment, a seal member SP is arranged at each of the four corners on the opposing surface (sealed surface) of the flange 115 in correspondence with the separated portions of the gasket 400. For example, as shown in FIG. 10, a recess 115c, which receives the seal member SP, is formed in formed in the corner at which a first lower flange portion 115a, which is sealed by the first segment 410, intersects a second lower flange portion 115b, which is sealed by the second segment 420. In this manner, in the first embodiment, the recess 115c is formed in each of the four corners of the lower flange 115 sealed by the gasket 400, and a seal SP is received in each recess 115c. For example, a closed pore type sponge is used as the seal SP, and the compression modulus of the seal SP is set to be greater than that of the gasket 400.

Referring to FIG. 11, the first segment 410 has an end portion (separated portion of the gasket 400) including a projection 411, a recess 412, and a projection 413. In the same manner, the second segment 420 has an end portion (separated portion of the gasket 400) including a recess 421 a projection 422, and a projection 423. The projection 411 and recess 412 of the first segment 410 respectively engage the recess 421 and the projection 422 of the second segment 420. The projection 423 of the second segment 420 is superimposed on the projection 413 of the first segment 410. A fastener 430, such as a rivet, is used to fasten the projections 413 and 423 and couple the first segment 410 and second segment 420. The first to fourth segments are formed in this manner, and adjacent segments are coupled to each other in the same manner. This forms the gasket 400 with the four segments. The projections 413 are 423 are formed at the inner side of the gasket 400 so as not to affect the coupling of the battery pack 100 to the battery container and the sealing performance. Here, a gap is formed between the coupled segments (e.g., first and second segments 410 and 420). That is, a clearance Sa is formed in each separated portion of the gasket 400.

Referring to FIG. 12A, each recess 115c of the lower flange 115 formed in a separated portion of the gasket 400 has a length Wa. The gap, or clearance Sa, formed between the coupled portions of the first segment 410 and the second segment 420 has a width Wb. The length Wa is greater than the width Wb (Wa>Wb).

The seal SP has a height W1 from the recess 115c (i.e., upper surface of the lower flange 115) prior to compression of the seal SP, and the gasket 400 has a thickness W2. The height W1 and the thickness W2 satisfy the relationship of condition (A), which is shown below.

W1>W2 (A)

As shown in FIG. 12B, when the upper case 120 is coupled to the lower case 110 with the gasket 400 arranged in between, the seal SP is deformed in accordance with the gap between the first segment 410 and the second segment 420, that is, in conformance with the shape of the clearance Sa formed in the separated portion of the gasket 400. Here, the seal SP, which is pressed by the surface of the upper flange 124 that opposes the lower flange 115, enters the clearance Sa. In this manner, the seal SP fills a space Sb surrounded by the lower flange 115 (in FIG. 12B, the first and second lower flanges 115a and 115b and the recess 115c), the gasket 400 (in FIG. 12B, the first and second segments 410 and 420), and the upper flange 124. That is, the seal SP is compressed between the lower surface of the gasket 400 and the bottom surface of the recess 115c and filled into the recess 115c. In this manner, the recess 115c, which is formed in the lower flange 115, prevents distortion and prevents the seal SP from producing ridges and valleys in the gasket 400 even though the seal SP is arranged between the lower flange 115 and the upper flange 124 to seal the clearance Sa. This eliminates gaps from the separated portions of the gasket 400. As a result, even though the gasket 400 is divided into segments, the original sealing performance of the gasket 400 can be maintained. The height W1 of the seal SP may be set in accordance with the compression modulus of the seal SP and the thickness W2 of the gasket 400.

In the first embodiment, the compression modulus of the seal SP is greater than that of the gasket 400. Accordingly, the seal SP is compressed more easily than the gasket 400. Thus, when pressure is applied to the seal SP, the seal SP fills the clearance Sa. In other words, the seal SP is flexibly deformed to fill the clearance Sa. In the first embodiment, the height W1 from the recess 115c and the thickness W2 of the gasket 400 satisfy the above-mentioned condition (A). Thus, the seal SP protruding from the recess 115c of the lower flange 115 is easily filled in the clearance Sa, and the compressed amount of the seal member SP is increased as the protruded amount of the seal SP increases.

In the first embodiment, the seal SP is filled in the clearance Sa, which is formed in each separated portion of the gasket 400. As a result, the gasket 400 and the seal SP appropriately seal the space between the lower flange 115 and the upper flange 124.

The seal structure using the gasket 400 of the first embodiment has the advantages described below.

(1) The recesses 115c are formed in the surface of the lower flange 115 that opposes the upper flange 124, and each recess 115c receives a seal SP. The length Wa of each recess 115c is greater than or equal to the width Wb of each separated portion of the gasket 400. When the upper case 120 is coupled to the lower case 110 with the gasket 400 arranged in between, the lower flange 115, upper flange 124, and gasket 400 apply pressure to each seal SP. This deforms the seals SP in accordance with the shapes of the clearances Sa in the gasket 400 and fills the recesses 115c with the seals SP. Thus, the gasket 400, which is formed by separate segments, seals the clearances Sa formed in the separated portions of the gasket 400 when sealing the space between the lower flange 115 and the upper flange 124. This maintains a high sealing performance with the gasket 400, which is formed by separate segments, and improves the material yield.

(2) The compression modulus of the seal SP is greater than the compression modulus of the gasket 400. This easily fills each clearance Sa of the gasket 400 with the corresponding seal member SP. As a result, the seal SP and the gasket 400 improve the sealing performance. Further, prior to the compression of the seal SP, the height W1 of each seal SP from the corresponding recess 115c and the thickness W2 of the gasket 400 satisfy the relationship of the above-mentioned condition (A). This increases the compression modulus of each seal SP and further appropriately seals each clearance Sa.

(3) The gasket 400 can be divided into segments that are separated at portions corresponding to the four corners of the lower flange 115 and the upper flange 124. More specifically, the gasket 400 can be divided into the first to fourth segments in correspondence with the four sides. The gasket 400 is formed by straight segments. This prevents the material that would be encompassed by the sides of the gasket 400 from being wasted and increases the material yield of the gasket 400.

(4) The seal SP is formed by a closed pore type sponge. This allows for the seals SP to be easily filled in the clearances Sa of the gasket 400. Thus, the clearances Sa can be further appropriately sealed.

(5) The seal structure that uses the gasket 400 is applied to the battery container that accommodates rechargeable batteries and seals the space between the lower case 110 and the upper case 120. More specifically, the gasket 400 and the seal SP seal the space between the lower flange 115 and the upper flange 124. Accordingly, the material yield of the gasket 400 is prevented from decreasing even when the circumferential length of the gasket 400 increases, and the sealing performance of the battery box is maintained.

(6) The lower case 110 and the upper case 120 each have a monocoque structure. Thus, the lower case 110 and the upper case 120 have a high sealing performance and a high sealing rigidity. This separates the interior of the battery container from the exterior of the battery container, while easily obtaining the rigidity of the battery compartment. In other words, there is no need for an element, such as an outer cover, that separates the interior and exterior of the battery container or a frame that ensures the rigidity of the battery container. Thus, when applying the seal structure that uses the gasket 400 to a battery pack that includes a battery container, a simplified structure can be obtained. This consequently decreases the number of components forming the battery pack that includes the battery container.

(7) The battery pack 100 is arranged in the vehicle frame Fr, which is part of the bed of the truck serving as an electric vehicle or a hybrid vehicle. Further, the battery pack 100 is used as a power supply for an electric motor that functions as a power source or auxiliary power source of the truck. In this case, the battery pack 100 is arranged outside the vehicle and is thus required to be hermetic and waterproof (moisture-proof). Accordingly, the seal structure including the gasket 400 and the seal SP is optimal for ensuring that the battery container is hermetic and waterproof. This increases the versatility of the battery pack 100.

### Second Embodiment

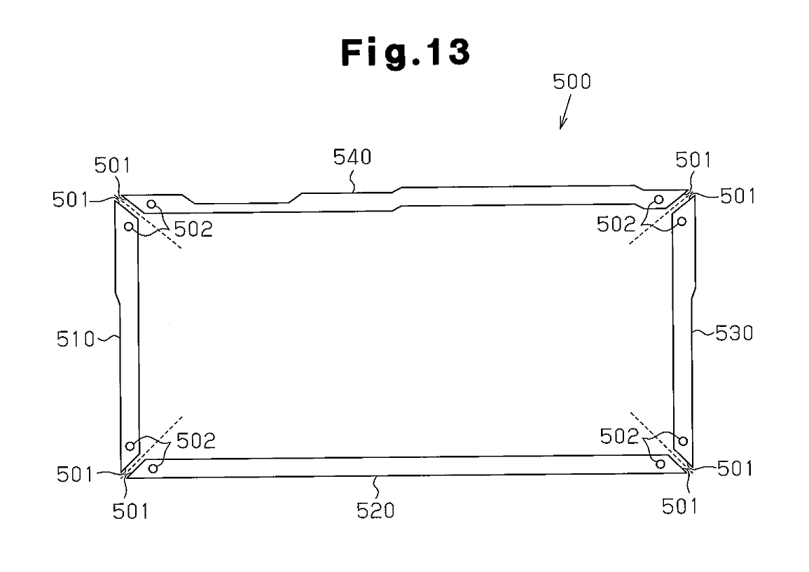

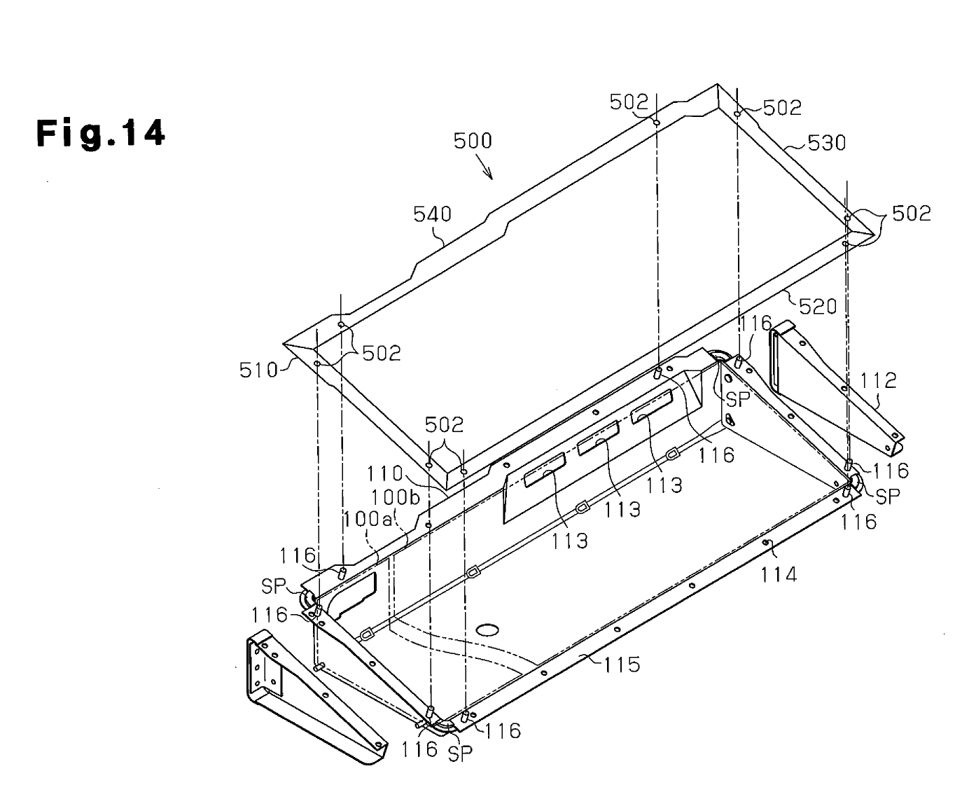

A seal structure according to a second embodiment of the present invention will now be described with reference to FIGS. 13 and 14 centering on differences from the first embodiment. The seal structure of the present embodiment is basically the same as the first embodiment. Like or same reference numerals are given to those components that are the same as the corresponding components of the first embodiment. Such components will not be described.

Referring to FIG. 13, in the same manner as the first embodiment, a gasket 500 of the second embodiment has a closed tetragonal shape that conforms to the shape of the lower flange 115 and upper flange 124 and includes four corners. The gasket 500 includes first to fourth segments 510, 520, 530, and 540, each corresponding to one side of the gasket 400.

The segments 510 to 540 each include ends defining separated end portions 501. Each separated end portion 501 includes an inclined face that extends along a diagonal line of the gasket 500. In a state in which the adjacent separated end portions 501 are opposed to each other at each vertex, the segments 510 to 540 are arranged between the lower case 110 and the upper case 120 to form the gasket 500 with the intended shape.

In the second embodiment, the segments 510 to 540 are not coupled to one another. Accordingly, the segments 510 to 540 do not include the projections 413 and 423 (FIG. 11) of the first embodiment that are fastened by the fasteners 430. In other words, the fasteners 430 (FIG. 10) such as rivets are unnecessary. In the second embodiment, each of the segments 510 to 540 includes a positioning hole 502 arranged near each end in addition to the coupling holes of the first embodiment (FIG. 10). The positioning holes 502 are used to position the segments 510 to 540 on the lower case 110 and the upper case 120. However, the positioning holes 502 are not essential. For example, the coupling holes 401 of the first embodiment may be used as the positioning holes. To facilitate illustration, the coupling holes 401 are not shown in FIGS. 13 and 14.

As shown in FIG. 14, in the second embodiment, for example, eight stud bolts 116 are used to couple the lower case 110 and upper case 120 of the gasket 500. The stud bolts 116 are formed near the ends of each side of the lower flange 115. The stud bolts 116 couple the lower case 110 and the upper case 120 to each other.

The stud bolts 116 are inserted into the positioning holes 502 to position the segments 510 to 540 on the lower flange 115 before the upper case 120 and lower case 110 are coupled to each other. This fixes the segments 510 to 540 of the gasket 500 to the lower flange 115 before inserting bolts into the coupling holes 114 of the lower case 110, the coupling holes 123 of the upper case 120, and the coupling holes 401 of the gasket 500. The positioning holes 502 guide the segments 510 to 540 to determined coupling positions and position the end portions 501 on the seals SP in the corresponding recesses 115c of the lower flange 115.

In a state in which the segments 510 to 540 are positioned relative to the lower flange 115 of the lower case 110, the upper flange 124 of the upper case 120 is coupled to the lower flange 115 with the segments 510 to 540 arranged in between. Although not shown in the drawings, nuts are fastened to the stud bolts 116 of the lower flange 115 that are inserted through coupling holes of the upper flange 124. This couples the lower case 110 and the upper case 120 in a state in which the gasket 500, which is formed by the segments 510 to 540, is arranged between the lower flange 115 and the upper flange 124.

In this manner, in the second embodiment, when pressure is applied to the segments 510 to 540 by the lower flange 115 and the upper flange 124, the segments 510 to 540 are in a non-overlapping arrangement. In this state, the separated end portions 501 are supported by the upper flange 124 and the seals SP, which are arranged in the corresponding recesses 115c of the lower flange 115. Thus, the segments 510 to 540 are maintained with the intended shape of the gasket 500 without using fasteners that coupled to the segments 510 to 540 to one another. Further, the stud bolts 116 are inserted into the positioning holes 502 arranged in the segments 510 to 540 to position the segments 510 to 540 at predetermined positions corresponding to each side of the lower flange 115. This prevents displacement of the segments 510 to 540 during use of the battery pack 100 and maintains the reliability of the gasket 500.

In addition to advantages (1) to (7) of the first embodiment, in the second embodiment, the seal structure that uses the gasket 500 has the advantages described below.

(8) The segments 510 to 540 of the gasket 500 are supported by the seals SP and the upper flange 124 in an non-overlapping arrangement. Accordingly, there is no need for fasteners that couple the segments 510 to 540 to one another. This allows the segments 510 to 540 to have further simple shapes. As a result, the productivity of the segments 510 to 540 is improved, the coupling of the gasket 500 to the battery pack 100 is facilitated, and the productivity of the battery pack 100 is improved.

(9) The positioning holes 502, which correspond to the stud bolts 116, are arranged at the two ends of each of the segments 510 to 540. This accurately guides the segments 510 to 540 to the determined positions between the lower flange 115 and the upper flange 124 when coupling the segments 510 to 540 to the battery pack 100. Further, the coupled segments 510 to 540 are prevented from being displaced during use of the battery pack 100. This maintains the sealing performance of the gasket 500.

### Third Embodiment

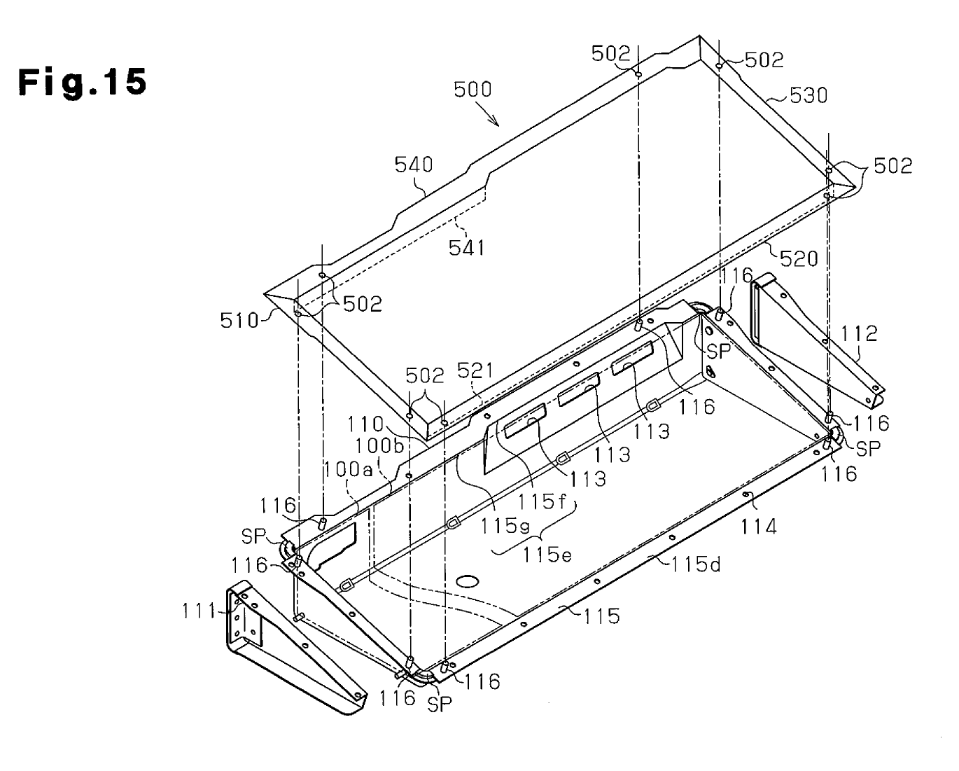

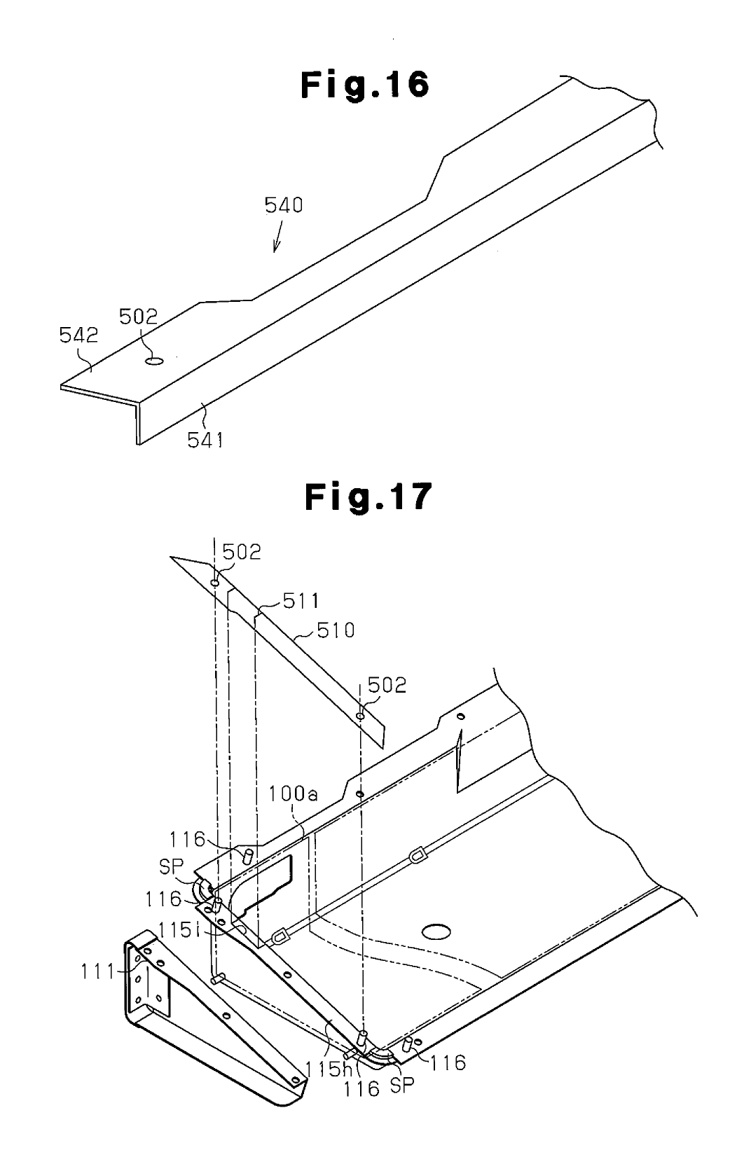

A seal structure according to a third embodiment of the present invention will now be described with reference to FIGS. 15 and 16 centering on differences from the first and second embodiments. The seal structure of the present embodiment is basically the same as the first and second embodiments. Like or same reference numerals are given to those components that are the same as the corresponding components of the first and second embodiments. Such components will not be described.

As shown in FIG. 15, in the third embodiment, the second and fourth segments 520 and 540 respectively include positioning flaps 521 and 541. The second and fourth segments 520 and 540 respectively correspond to long sides 115d and 115e of the lower flange 115, which are relatively long.

The long side 115e of the lower flange 115 includes an expanded portion 115f, which expands at a location corresponding to the air outlets 113, and a straight portion 115g, which extends straight from the expanded portion 115f. In the third embodiment, the flap 541 of the fourth segment 540 corresponding to the long side 115e is arranged, for example, at a region corresponding to only the straight portion 115g of the long side 115e.

Further, as shown in FIG. 16, the fourth segment 540 includes a sealing region 542, which is arranged on the long side 115e of the lower flange 115 to seal the long side 115e. The flap 541 of the fourth segment 540 is bent at a right angle at the inner side of the lower flange 115.

When coupling the second segment 520 and the fourth segment 540 to the lower case 110, the flaps 521 and 541 are arranged in contact with an inner wall of the lower case 110. This determines the positions of the second and fourth segments 520 and 540 on the long sides 115d and 115e of the lower case 110, respectively. Thus, the second and fourth segments 520 and 540 are accurately fixed to the long sides 115d and 115e of the lower case 110.

In addition to advantages (1) to (9) of the above embodiments, in the third embodiment, the seal structure that uses the gasket 500 has the following advantage.

(10) The second and fourth segments 520 and 540, which correspond to the long sides 115d and 115e of the lower flange 115, include the positioning flaps 521 and 541. This accurately positions the second and fourth segments 520 and 540 on the long sides 115d and 115e of the lower flange 115, while forming the gasket 500 with the segments 510 to 540. The arrangement of the flaps 521 and 541 on the second and fourth segments 520 and 540 relatively increases the rigidity of the second and fourth segments 520 and 540 as compared with the first and third segments 510 and 530. This keeps the shapes of the second and fourth segments 520 and 540 stable. As a result, the transportation of the second and fourth segments 520 and 540 and the coupling of the second and fourth segments 520 and 540 to the lower flange 115 are efficiently performed.

### Fourth Embodiment

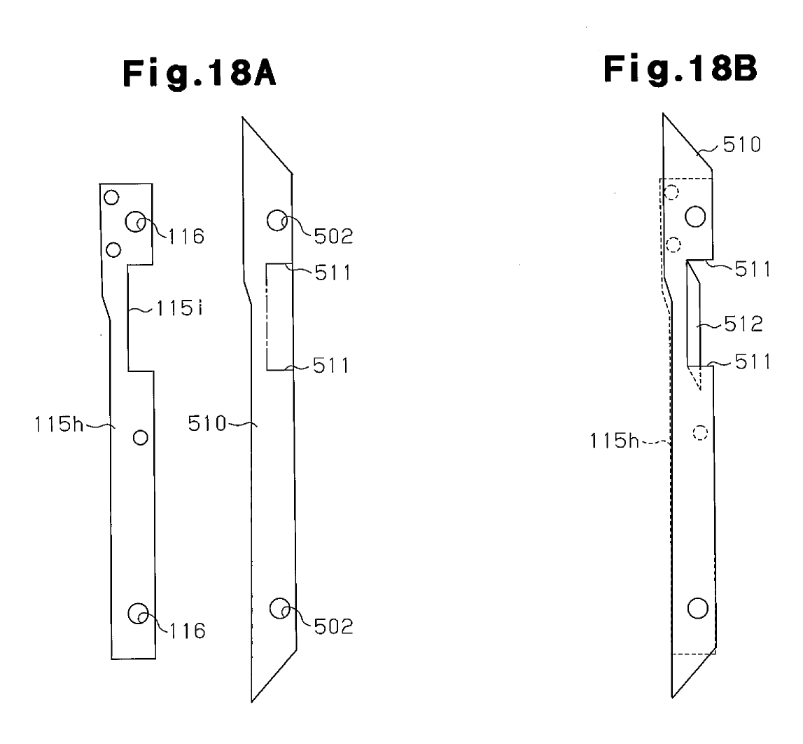

A seal structure according to a fourth embodiment of the present invention will now be described with reference to FIGS. 17 and 18 centering on differences from the first and second embodiments. The seal structure of the present embodiment is basically the same as the first and second embodiments. Like or same reference numerals are given to those components that are the same as the corresponding components of the first and second embodiments. Such components will not be described.

As shown in FIG. 17, in the fourth embodiment, the lower flange 115 includes a cutout 115i formed in each of two short sides 115h of the lower flange 115, which are relatively short. The cutouts 115i determine the positions of the corresponding segments. More specifically, the cutout 115i of the short side 115h sealed by the first segment 510, determines the position of the first segment 510. In the same manner, although not shown in the drawings, the cutout 115i of the short side 115h sealed by the third segment 530, determines the position of the third segment 530. The first segment 510 includes two slits 511 formed in conformance with the corresponding cutout 115i. In the same manner, although not shown in the drawings, the third segment 530 includes two slits 511 formed in conformance with the corresponding cutout 115i.

Referring to FIG. 18A, when coupling the first segment 510 to the short side 115h of the lower flange 115, a region 512 located between the two slits 511 is bent toward the inner wall of the lower case 110. The bending of the region 512 toward the inner wall of the lower case 110 determines the position of the first segment 510 on the corresponding short side 115h of the lower case 110. In the same manner, the position of the third segment 530 is determined on the short side 115h of the lower case 110.

In addition to advantages (1) to (9) of the above embodiments, in the fourth embodiment, the seal structure that uses the gasket 500 has the following advantage.

(10A) The two short sides 115h of the lower flange 115 each include the cutout 115i. Further, the first and third segments 510 and 530, which seal the two short sides 115h, include the slits 511. This accurately positions the first and third segments 510 and 530 on the short sides 115h of the lower flange 115, while forming the gasket 500 with the segments 510 to 540. The slits 511 and the cutouts 115i determine the positions of the first and third segments 510 and 530. This simplifies the shapes of the first to fourth segments 510 to 540, while allowing for positioning of the segments 510 and 530.

### Fifth Embodiment

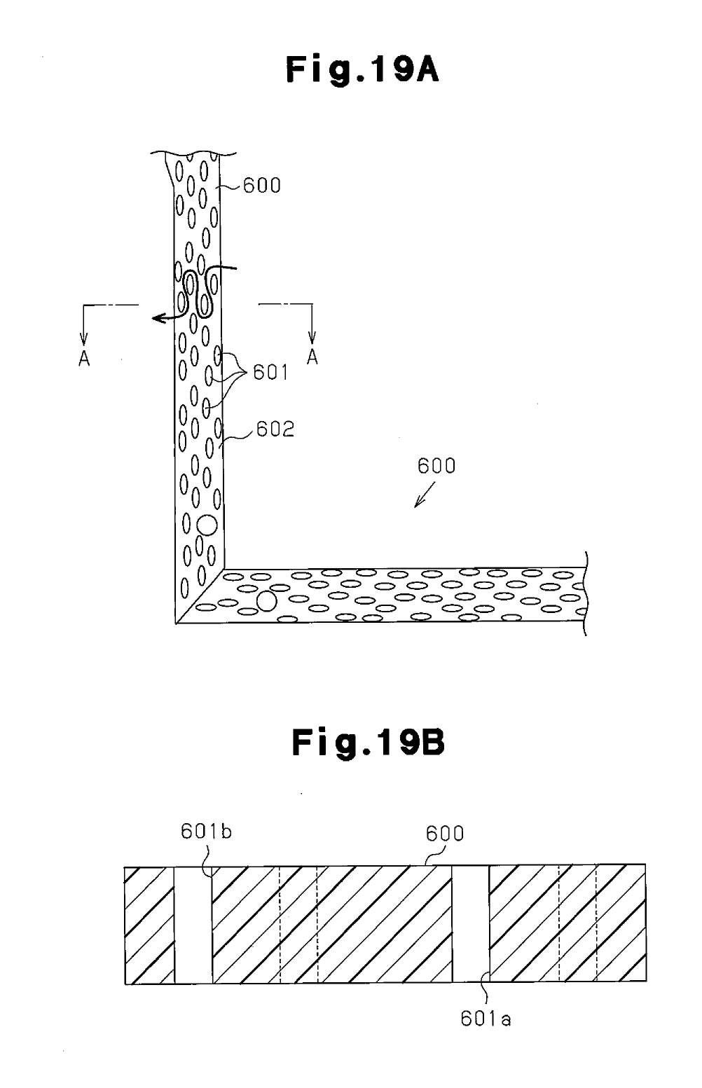

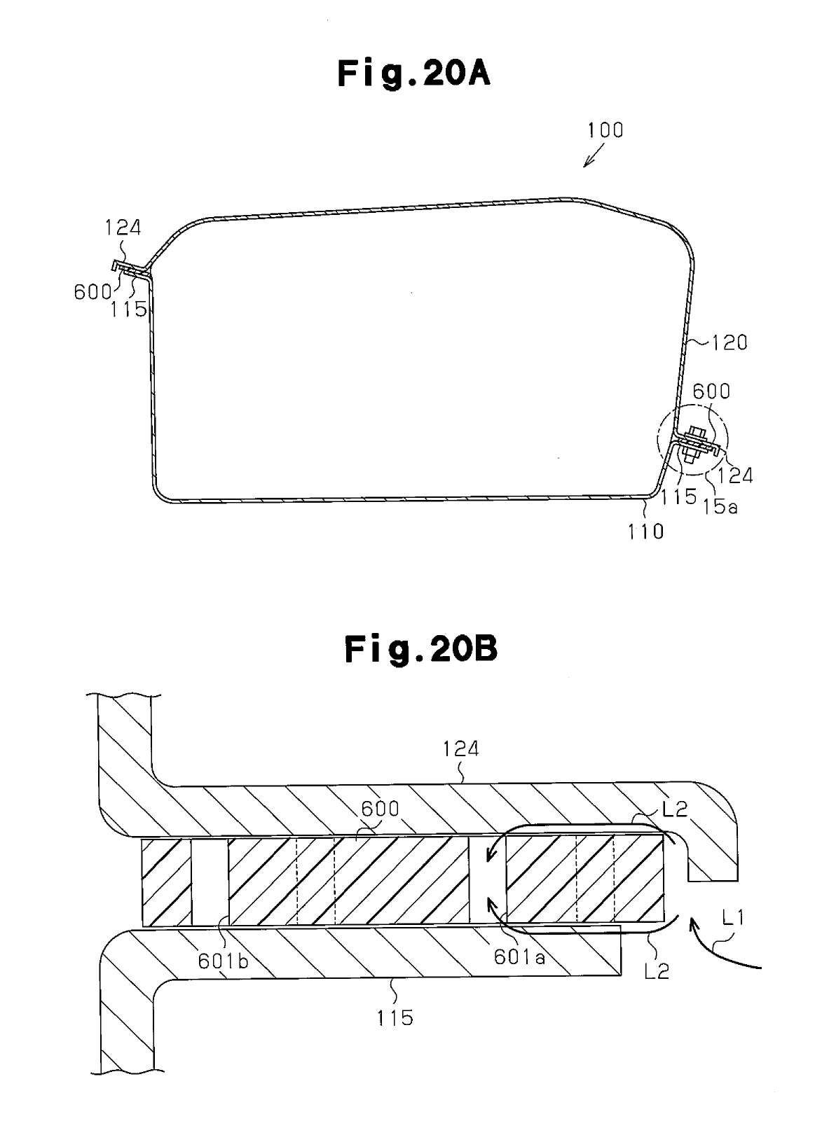

A seal structure according to a fifth embodiment of the present invention will now be described with reference to FIGS. 19 and 20 centering on differences from the first and second embodiments. The seal structure of the present embodiment is basically the same as the first and second embodiments. Like or same reference numerals are given to those components that are the same as the corresponding components of the first and second embodiments. Such components will not be described.

Referring to FIG. 19A, in the fifth embodiment, to improve the sealing performance of a gasket 600, a plurality of holes 601 extend through the gasket 600 between sealing surfaces that are arranged in contact with the lower case 110, the upper case 120, and the seals SP. The holes 601 are arranged in, for example, a zigzagged pattern. Thus, in the fifth embodiment, as shown by the arrow in FIG. 19A, a path connecting inner and outer areas of the gasket 600 detour the holes 601 and extend in a complicated manner.

FIG. 19B is a cross-sectional view of the gasket 600 taken along line A-A in FIG. 19A. Due to the formation of the holes 601 in the gasket 600, holes 601a and 601b divide the gasket 600, as shown in FIG. 19B.

The operation of the fifth embodiment will now be described with reference to FIG. 20.

FIG. 20A is a cross-sectional view of the battery pack 100 and the gasket 600 taken from the short side of the battery pack 100. As shown in FIG. 20A, in the battery pack 100, the gasket 600 is arranged between the lower flange 115 of the lower case 110 and the upper flange 124 of the upper case 120. The gasket 600 separates the inner and outer areas of the battery pack 100 (battery container).

FIG. 20B is an enlarged view of region 15a, which is encircled in FIG. 20A. When the battery pack 100 is emerged in a large mass of liquid such as water, liquid enters the battery pack 100 as shown by arrow L1 in FIG. 20B.

The gasket 600 blocks most of the liquid. However, capillary action results in some of the water moving toward the inner area of the battery pack 100 through fine gaps formed between the gasket 600 and the lower flange 115 and between the gasket 600 and the upper flange 124 as shown by arrow L2 in FIG. 20B.

In the fifth embodiment, however, due to the formation of the holes 601 (601a and 601b) in the gasket 600, the capillary action does not occur in the region in which the holes 601 (601a and 601b) are formed. This prevents liquid from entering the inner area of the battery pack 100. In other words, the holes 601 block the entrance of liquid caused by a capillary action. Further, the holes 601 are arranged in a zigzagged pattern in the sealing surfaces of the gasket 600. This causes the path of the liquid moved by a capillary action being complicated, and the liquid must avoid the holes 601 to enter the inner area of the battery pack 100. Thus, the liquid is prevented from entering the battery pack 100. In this manner, even when the battery pack 100 is emerged in a large mass of liquid, the entrance of liquid into the battery pack 100 resulting from the capillary action is prevented, and the battery pack 100 is maintained in the sealed state.

In addition to advantages (1) to (9) of the above embodiments, in the fifth embodiment, the seal structure that uses the gasket 600 has the following advantage.

(11) The sealing surfaces of the gasket 600 include the holes 601 that are arranged in a zigzagged pattern. Further, the holes 601 block the entrance of liquid. This prevents water from being moved by capillary action into the inner area of the battery pack 100 through fine gaps formed between the gasket 600 and the lower flange 115 and between the gasket 600 and the upper flange 124. Thus, the sealed state of the battery pack 100 is maintained in an optimal state. Further, since the entrance of liquid can be prevented, even when decreasing the width of the gasket 600, a sufficient sealing performance can be maintained. Thus, the widths of the lower flange 115 and the upper flange 124 may be decreased to reduce the size of the entire battery pack 100. The holes 601 of the gasket 600 may decrease rigidity. However, the gasket 600 is formed by a plurality of segments. Thus, the decreased rigidity does not affect the handling of the gasket 600.

It should be apparent to those skilled in the art that the present invention may be embodied in many other specific forms without departing from the spirit or scope of the invention. Particularly, it should be understood that the present invention may be embodied in the following forms.

In the fifth embodiment, the holes 601 are arranged in a zigzagged pattern in the sealing surfaces of the gasket 600. However, the holes 601 of the gasket 600 may be arranged in any pattern. For example, holes may be arranged at predetermined intervals in one or more lines along the longitudinal direction of the gasket 600. Further, the portions of the battery pack 100 that are likely to be exposed to water during use of the battery pack 100 may be specified, and holes may be concentrated in the sealing surfaces of the gasket 600 at locations corresponding to the specified portions.

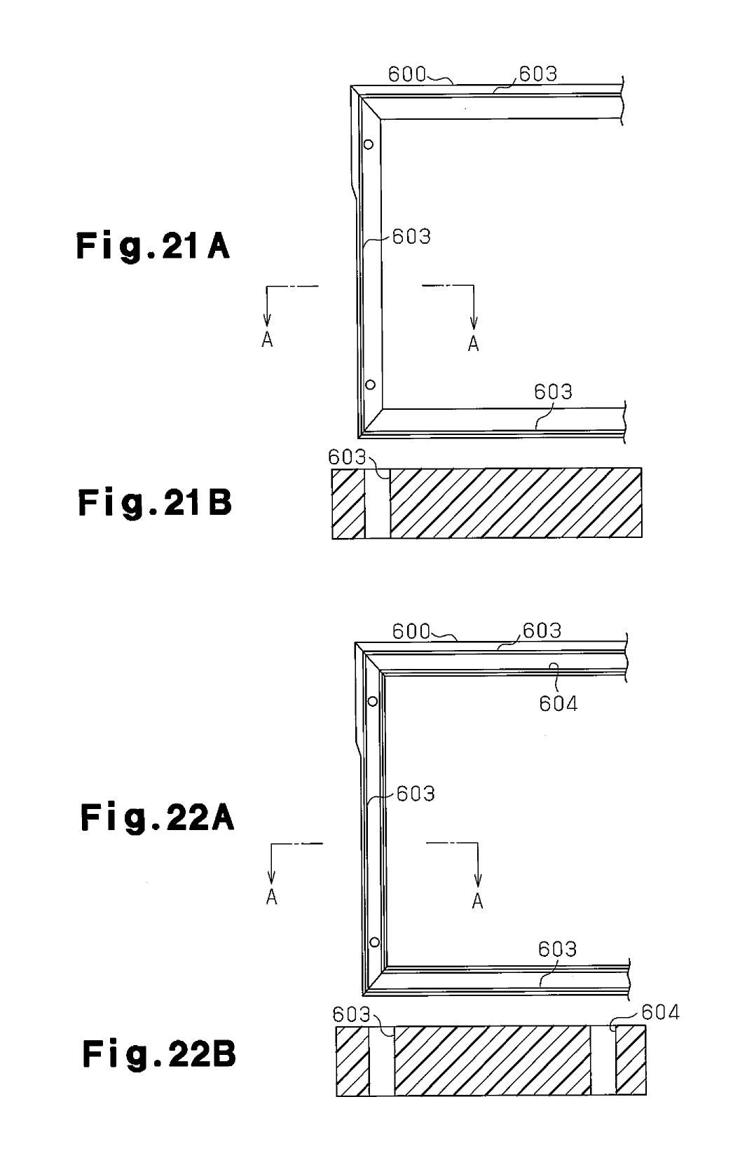

Referring to FIGS. 21A and 21B, which respectively correspond to FIGS. 20A and 20B, a single hole 603 may be formed extending along the entire gasket 600. In the same manner, as shown in FIGS. 22A and 22B, an outer hole 603 and an inner hole 604 may be formed extending along the entire gasket 600. Further, such holes may be formed in predetermined intervals in the sealing surface of the gasket 600.

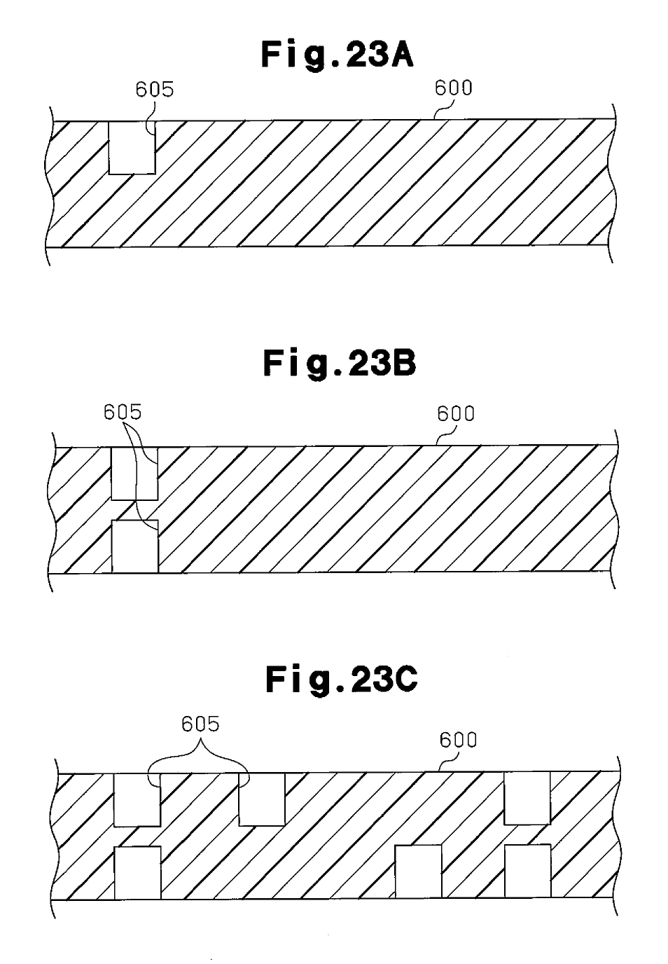

As shown in FIG. 23A, which corresponds to FIG. 22B, among the two sealing surfaces of the gasket 600, a groove 605 may be formed in one of the sealing surfaces. In the same manner, as shown in FIG. 23B, each sealing surface of the gasket 600 may include a groove 605 that extends along the entire gasket 600. Further, as shown in FIG. 23C, each sealing surface of the gasket 600 may include a plurality of grooves 605 that extend along the entire gasket 600. In this case, the grooves 605 may be arranged in a zigzagged pattern. Further, a hole and a groove may both be formed in a gasket. As long as the liquid that enters the battery pack 100 due to a capillary action can be prevented, the quantity and location of the holes or grooves formed in the gasket 600 may be varied.

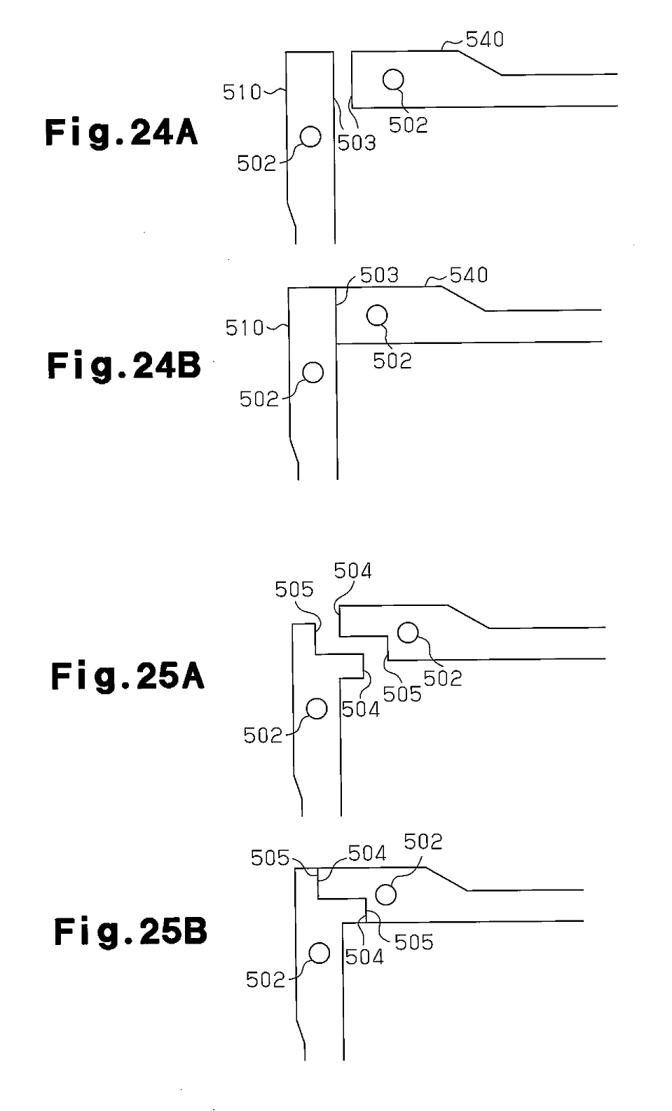

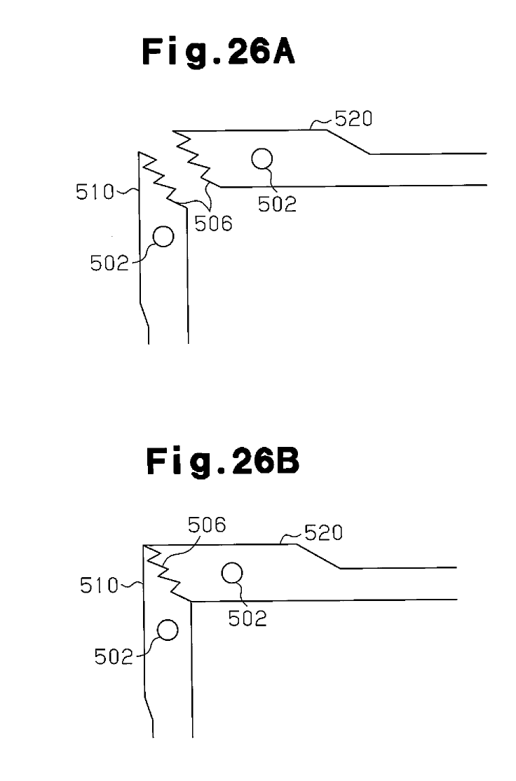

In the second to fifth embodiments, the separated end portions 501 of the segments 510 to 540 forming the gasket 500 (600) each include an inclined face extending along a diagonal line of the gasket 500. However, the present invention is not limited in such a manner. For example, as shown in FIGS. 24A and 24B, separated end portions of the segments 510 to 540 may include a face 503 that is orthogonal to a side of the adjacent segment. Further, for example, as shown in FIGS. 25A and 25B, the separated end portions of the segments 510 to 540 may each include a projection 504 and a recess that engage with the separated end portion of the adjacent segment. As shown in FIGS. 26A and 26B, the separated end portions of the segments 510 to 540 may include a plurality of projections 506 that engage with the separated end portion of the adjacent segment. This obtains the afore-mentioned advantage (10). The structure shown in FIGS. 26A and 26B increases the length of contact between the separated end portions of the segments 510 to 540. This lengthens the path of the entering liquid at each separated end portion. Thus, the effect for preventing the entrance of liquid through gaps between separated end portions can be increased.

In the third embodiment, the second and fourth segments 520 and 540 corresponding to the long sides 115d and 115e of the lower flange 115 includes the flaps 521 and 541. In the fourth embodiment, the short sides 115h of the lower flange 115 each include the cutout 115i, and the first and third segments 510 and 530 that seal the short sides 115h each include the slits 511. The present invention is not limited in such manner, and the third and fourth embodiments may be combined. In such a case, the segments 510 to 540 of the gasket 500 are positioned by the corresponding sides of the lower flange 115. Thus, the segments 510 to 540 are positioned in a further stable state on the lower flange 115. Alternatively, the long sides 115d and 115e of the lower flange 115 may each include a cutout, and the second and fourth segments 520 and 540 that seal the long sides 115d and 115e may include corresponding slits. In the same manner, the first and third segments 510 and 530 that seal the short sides 115h of the lower flange 115 may each include a flap similar to that of the third embodiment. Further, the segments 510 to 540 may each include a plurality of flaps or slits.

In the second to fifth embodiments, the two ends of the each of the segments 510 to 540 include the positioning holes 502, which correspond to the stud bolts 116. However, the positioning holes 502 do not have to be arranged on both ends of each of the segments 510 to 540. In other words, the stud bolts 116 do not have to be arranged on both ends of each side of the lower flange 115. A positioning hole 502 or stud bolt 116 may be arranged in the middle of each of the segments 510 to 540 or in the middle of each side of the lower flange 115. Further, the quantities of the positioning holes 502 and the stud bolts 116 are not limited and are variable. Additionally, the widths of the sealing surfaces of the segments 510 to 540 may be decreased so as not to include portions corresponding to the stud bolts 116. Alternatively, the locations of the stud bolts 116 may be changed so that the stud bolts 116 do not overlap the sealing surfaces of the segments 510 to 540. In this structure, the positioning holes 502 may be eliminated from the gasket 500. In such a case, the seals SP, which fill the recesses 115c of the lower flange 115, and the upper flange 124 position the separated end portions 501 of the segments 510 to 540 between the lower flange 115 and the upper flange 124.

In the first embodiment, the fasteners 430, which are rivets or the like, are used to couple adjacent segments of the gasket 400. The present invention is not limited in such a manner, and adjacent segments may be coupled to each other by an adhesive agent or by performing welding. Further, the segments may be held between the lower flange 115 and the upper flange 124 without coupling the segments. This fixes the position of each segment.

In the above embodiments, a closed pore type sponge is used to form the seal SP. The present invention is not limited in such a manner. Any material that can fill and seal each recess 115c of the lower flange 115 and each clearance Sa of the gasket may be used to form the seal SP.

In the above embodiments, the recesses 115c are formed in the surface of the lower flange 115 that is opposed to the upper flange 124. The present invention is not limited in such a manner, and the recesses 115c may be formed in the surface of the upper flange 124 that is opposed to the lower flange 115.

In the above embodiments, the compression modulus of the seal SP is greater than that of the gasket 400. Further, the height W1 of the seal SP from the recess 115c prior to compression and the thickness W2 of the gasket 400 are set to satisfy the relationship of W1>W2. However, the present invention is not limited in such a manner. For example, as long as the seal SP filled in the recess 115c can be deformed to seal the clearance Sa of the gasket, the compression modulus of the seal may be less than or equal to that of the gasket. In the same manner, as long as the seal SP filled in the recess 115c can be deformed to seal the clearance Sa of the gasket, the height W1 of the seal SP from the recess 115c prior to compression and the thickness W2 of the gasket W2 may be set to satisfy the relationship of W1≦W2.

In the above embodiments, the length Wa of the recess 115c is greater than the width Wb of the separated portion. However, the present invention is not limited in such a manner. As long as the seal SP filled in the recess 115c can be deformed to seal the clearance Sa of the gasket 400, the length Wa of the recess 115c and the width Wb of the gasket may be set to be equal.

In the above embodiments, the gasket 400 is tetragonal to conform to the closed shape of the lower flange 115 and upper flange 124, each of which forms a sealed subject surface. Further, the separated portions of the gasket 400 are arranged in correspondence with the four corners of the lower flange 115 and upper flange 124. However, the separated portion of the gasket 400 may be arranged in at least one of the four corners, and the recess 115c, which receives the seal SP, may be arranged at a position corresponding to the separated portion. The separated portion may also be arranged in the middle of each side of a gasket. Further, the shapes of the sealed subject surface and gasket are not limited to closed tetragons. For example, the sealed subject surface and gasket may be elliptical or circular. Further, the gasket does not have to have a closed shape.

In the above embodiments, the lower case 110 and the upper case 120 have monocoque structures. However, the present invention is not limited in such a manner. The batter container may be a conventional battery container that is formed by upper and lower cases. Further, an outer cover may be used to isolate the battery container from the ambient air.

In the above embodiments, the battery pack 100 serves as a power supply unit for an electric motor of a truck, which is an electric vehicle or a hybrid vehicle. The battery pack 100 is arranged on the vehicle frame Fr, which is part of the vehicle bed. However, the present invention is not limited in such a manner. The battery pack 100 may be arranged at any location, such as on a vehicle body or in a cargo frame of a truck.

In the above embodiments, when fastening the lower case 110 and the upper case 120 in the battery container, which accommodates rechargeable batteries, a gasket seals the opposing surfaces of the lower flange 115 and upper flange. The present invention is not limited in such a manner. The subjects sealed by the seal structure may be the body and lid of a case that accommodates electronic devices such as a hard disk drive. It is only required that the subjects sealed by the seal structure be two surfaces between which a gasket is arranged.

The present examples and embodiments are to be considered as illustrative and not restrictive, and the invention is not to be limited to the details given herein, but may be modified within the scope and equivalence of the appended claims.

1. A seal structure comprising:
a gasket arranged between two sealed subject surfaces, wherein the gasket includes a plurality of segments;
a recess arranged in one of the two sealed subject surfaces at a portion corresponding to a clearance between adjacent ones of the plurality of segments; and
a seal filled in the recess and deformed in conformance with the shape of the clearance between the segments.

2. The seal structure according to claim 1, wherein when the seal has a height W1 from the recess prior to compression of the seal and the gasket has a thickness W2, the height W1 and the thickness W2 satisfy the relationship of W1>W2.

3. The seal structure according to claim 1, wherein:
the segments are in a non-overlapping arrangement, and
the gasket includes a separated portion arranged between the adjacent ones of the segments, wherein the separated portion is supported by one of the two sealed subject surfaces that is opposed to the recess and by the seal filled in the recess.

4. The seal structure according to claim 1, wherein the segments each include two sealing surfaces and one or more holes extending between the two sealing surfaces.

5. The seal structure according to claim 1, wherein the segments each include two sealing surfaces, and at least one of the two sealing surfaces includes one or more grooves.

6. The seal structure according to claim 4, wherein at least one of the two sealing surfaces further includes one or more grooves.

7. The seal structure according to claim 4, wherein the holes are arranged in a zigzagged pattern.

8. The seal structure according to claim 5, wherein the grooves are arranged in a zigzagged pattern.

9. The seal structure according to claim 1, wherein the two sealed subject surfaces and the gasket each have a closed shape and includes a corner, and the gasket includes a separated portion arranged between the adjacent ones of the plurality of segments, wherein the separated portion is arranged at the corner.

10. The seal structure according to claim 1, wherein the seal is formed by a closed pore type sponge.

11. The seal structure according to claim 1, wherein the seal structure is applied to a seal for an upper case and a lower case of a battery container that accommodates a rechargeable battery, the two sealed subject surfaces are a flange of the upper case and a flange of the lower case, which are opposed to each other.

12. The seal structure according to claim 11, wherein the upper case and the lower case each have a monocoque structure.
